(19) United States
(12) Patent Application Publication
(10) Pub. No.: US 2003/0168017 A1
(43) Pub. Date: Sep. 11, 2003

(54) Cat outhouse and method for using same

(76) Inventors: Jack Aldon Perelli, Port Orchard, WA (US); Fern Ellouise Perelli, Port Orchard, WA (US)

Correspondence Address: LAW OFFICE OF POLLY L. OLIVER, P.O. BOX 4625, FEDERAL WAY, WA, 98063, US

(21) Appl. No.: 10/383,988

(22) Filed: Mar. 8, 2003

Related U.S. Application Data
(60) Provisional application No. 60/363,299, filed on Mar. 9, 2002.

(51) Int. Cl. A01K 29/00

(52) U.S. Cl. 119/165

(57) ABSTRACT

A new and improved cat outhouse provides for a cleaner and healthier way to care for an indoor cat. The cat outhouse attaches to the exterior of a house and comprises a box-like shelter, a litter pan, and at least one pass-through door so that the cat can enter the litter box from the inside of the house. The outhouse also has a ventilation system which helps to dissipate the smell and dust. Although regular changing of the cat litter is still necessary, the job is much easier and cleaner with the new invention. The cat pan can be removed from a slidable drawer at the bottom of the shelter, or in alternate embodiments, through the top opening of the shelter.

### RELATED APPLICATION

This application claims priority under 35 U.S.C. 119(e) to U.S. provisional application Serial No. 60/363,299, filed on Mar. 9, 2002.

### FIELD OF THE INVENTION

This invention pertains generally to pet accessories and more specifically to a new and improved cat shelter for enclosing a litter pan.

### BACKGROUND OF THE FIELD

Cats are popular pets in this country, and indoor cats need litter pans. There are many types of litter pans, or boxes, out on the market today; however, conventional litter pans are problematic in that they are smelly and messy. In addition, conventional litter pans present a health risk to those humans living in the house who may be exposed to the soiled litter and also the litter dust kicked up by the cat. Particularly, the condition known as toxoplasmosis is associated with soiled cat litter and may lead to miscarriage, stillbirth, or various growth problems. Many of the interior rooms of a house do not have the necessary ventilation to carry away the noxious fumes and dust from the litter pan, and of course, there remains the ever-present problem of changing the litter.

There have been past efforts to address some of these problems, which have been patented. For instance, in U.S. Pat. No. 6,439,161, Clemmons discloses a litterbox enclosure for mounting on the exterior of a house. Although this invention removes the litter box from the interior environment, Clemmons' invention is a complicated design with small parts in that it includes pivotal means for changing the litter, and complicated collection means therefor.

### SUMMARY OF THE INVENTION

The present invention solves the above-mentioned problems by providing a cat outhouse for a litter pan that can be attached to the exterior of a house—or the interior with appropriate ventilation. The invention not only removes the litter pan with its attendant smell, mess, and dust from the interior living quarters of the house, but also enables a cat's caretaker to change the litter from the exterior of the house. Moreover, the arrangement proves to be healthier for the inhabitants of the house.

The invention of the cat outhouse comprises a shelter, a drawer therein which may or may not have a separate litter pan, and a pass-through door for the cat, all of which can be variously sized to fit any domesticated feline or other pet. The shelter of the preferred embodiment is a box-like structure made of UV-approved plastic, including a solid bottom panel, four vertical side panels, and a removable top panel. (Other materials such as wood, metal, or vinyl could be used, but plastic was chosen for its durability and aesthetic appearance.) The shelter is intended to be attached to the side of the house using a variety of methods, which may include direct attachment with screws or bolts, or a sliding mechanism in such cases where direct attachment is not possible. The shelter of the preferred embodiment includes the drawer in the lower portion thereof, the front of which is oriented towards the front side of the shelter, i.e., the side facing away from the house.

If a separate litter pan is used, then the litter pan is placed inside the drawer inside the shelter and is a conventional pan for holding conventional cat litter. (If a separate litter pan is not used, then the litter can be placed directly into the drawer, perhaps with an appropriate liner.) The litter pan can be easily removed for cleaning and maintenance when the drawer is extended from the outside. In alternate embodiments, the litter pan can be removed upward through the open roof of the outhouse when the top panel has been removed. Also, with the top panel removed, the caretaker can easily clean out the entire shelter with a hose or other method.

The pass-through door for the cat fits through openings cut into the back panel of the outhouse and directly through the wall of the house so that the cat can enter the outhouse from the interior of the house and does not need to go outside. The pass-through door includes frames that fit into these openings and an expandable entry tunnel that can accommodate various wall thicknesses.

### BRIEF DESCRIPTION OF THE DRAWINGS

FIG. 1 is a perspective view of the preferred embodiment of the cat outhouse as it is intended to be attached to the exterior of a house;

FIG. 2 is an exploded view of the invention showing the drawer and the pass-through door; and

FIG. 3 is a sectional view of the invention showing the pass-through door arrangement with expanded tunnel.

### DETAILED DESCRIPTION OF THE PREFERRED EMBODIMENT

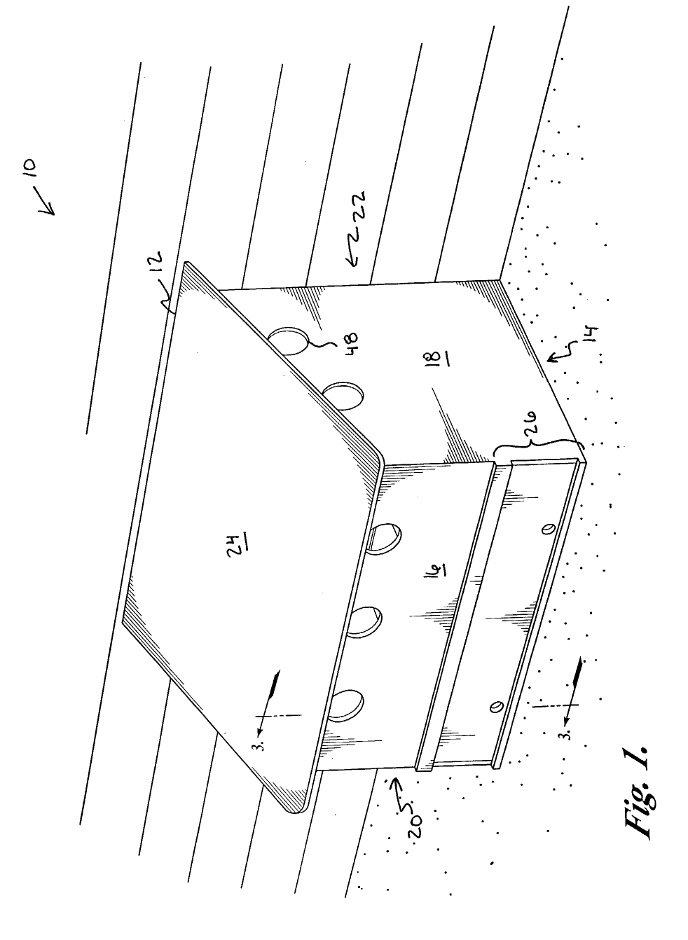

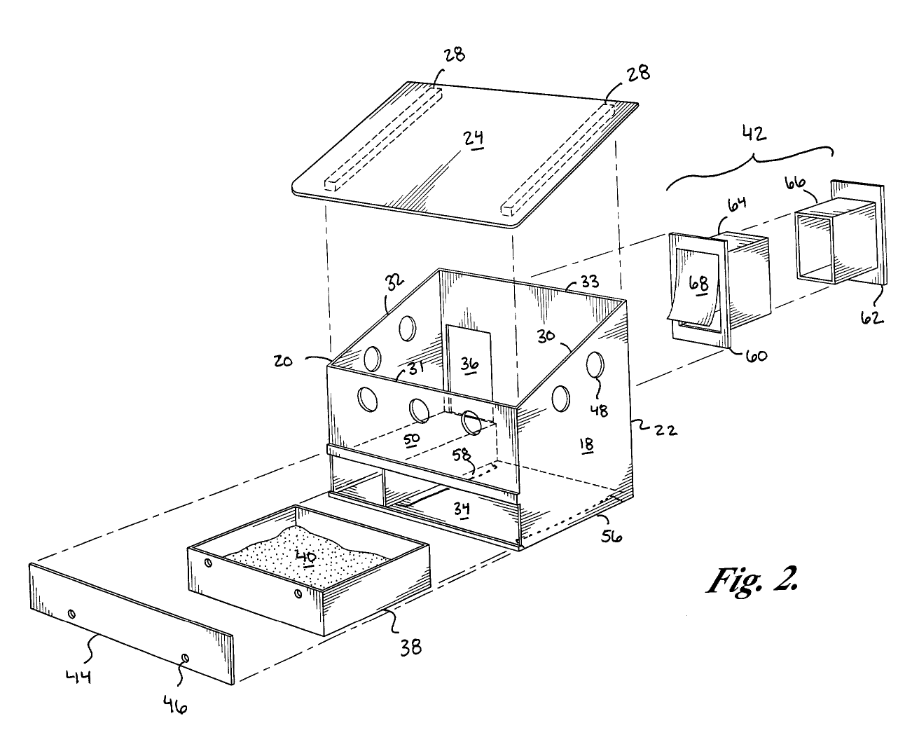

FIG. 1 shows the invention of the cat outhouse 10 as it is intended to be mounted to an exterior wall 11 of a house. The shelter 12 comprises a bottom panel 14 (best shown in FIG. 2) that rests on the ground or other generally horizontal surface, such as a patio, and supports the front panel 16, the side panels, 18 and 20, and the back panel 22 (also better shown in FIG. 2), which is relatively flush against the house wall 11. Bolts or screws can be used as appropriate to attach the back panel 22 to the house wall 11.

The top panel 24 overhangs the front and side panels and in the preferred embodiment has rounded corners to improve both safety and appearance. Several ventilation holes, typified by 48, are located proximate the upper edges 30, 31, and 32 (shown in FIG. 2) in order to allow for dissipation of the smells, odors, and dust from the litter box within the shelter 12. In alternate embodiments, the litter pan 40, if a separate litter pan is used, can be removed through the open top of the shelter 12—with the top panel 24 removed. Also, with the top panel 24 removed, the caretaker can easily clean the entire inside of the shelter 12, by hosing it down, wiping it down, or by some other method.

FIG. 2 shows how the top panel 24 is removable from the shelter 12. Because it overhangs the side panels 18 and 20, the top panel 24 can be easily lifted off, and when replaced, the stops 28 fit within the upper edges 30, 31, 32, and 33.

Looking together at FIG. 1 and FIG. 2, the lower portion 26 of the front panel 16 defines an opening 34 that accommodates a removable front cover 44. The drawer 38 fits within the shelter 12 so that in its fully retracted position, the front cover 44 can be put in place to cover the opening 34. The drawer 38 extends outwardly through the opening 34 using sliding means mounted between the bottom panel 22 and the drawer 38 so that a caretaker can easily change the litter in the litter pan 40. (The litter pan 40 can be a separate pan (not shown) or can be the drawer itself.) In the preferred embodiment, the drawer 38 slides on two plastic runners 56 and 58 which are mounted to the bottom panel 14 on the inside of the shelter 12. Both the front cover 44 and the drawer 38 define finger holes, typified by 46, instead of hardware that can rust, jam, or otherwise malfunction and be problematic.

FIG. 2 also shows how a facing strip 52 is mounted to the lower portion 26 of the front panel 16. The facing strip 52 facilitates retention of the front cover 44, which can be removed in its entirety to provide access to the drawer 38 and the storage box 50. The storage box 50 provides a place for a litter scoop, gloves, or other tools (not shown). The top of the storage box 50 also provides a landing area for the cat when it emerges from the pass-through door 42 into the shelter 12 before it steps into the litter pan 40.

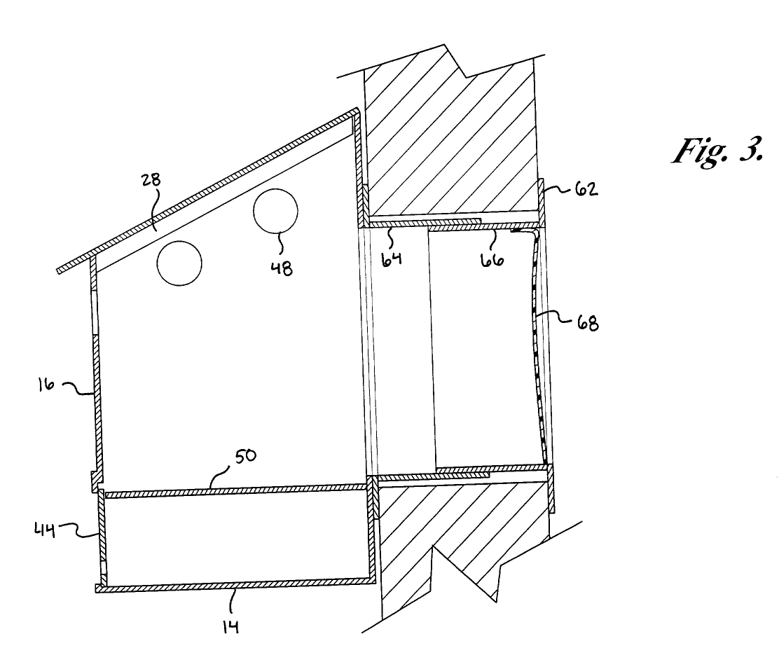

The pass-through door 42 comprises a first frame 60, which fits into the opening 36 in the back panel 22, a second frame 62 which fits into a cutout (not shown) in the house wall 11, and an expanding entry tunnel between the frames, both frames sized to accommodate a cat. The entry tunnel (which in the preferred embodiment has a generally rectangular cross-section) includes a first tunnel part 64 and a second tunnel part 66, which parts nest and slide relative to each other and can expand or contract the tunnel in order to accommodate various wall thicknesses, generally 4 inches to 6 inches. In addition, one of the frames further includes a flap 68. The flap 68 can be attached to either frame, 60 or 62, and is shown on different frames in FIG. 2 and FIG. 3; however, in the preferred embodiment, the flap 68 is attached to the second frame 62, the one in the house wall cutout.

What is claimed is:

1. A cat outhouse comprising:
a generally box-like shelter having a generally planar solid bottom panel, a front panel, a back panel and two side panels, all panels being mounted to the bottom panel and extending upwardly therefrom so that the front, back and side panels have lower portions proximate the bottom panel and also define upper edges, and a generally planar top panel removably mounted onto said upper edges so that the top panel slopes generally downwardly from the back panel toward the front panel, the front panel further defining an opening in the lower portion thereof to accommodate a drawer, and the back panel also defining an opening to accommodate a pass-through door;
a drawer sized to fit within the shelter, such drawer being slidably mounted onto the bottom panel and being capable of slidably extending outwardly through the opening in the lower portion of the front panel of the shelter; and a pass-through door capable of fitting into the opening in the back panel of the shelter and sized to accommodate a cat.

2. The cat outhouse of claim 1 further comprising a cat litter pan sized to fit within the drawer.

3. The cat outhouse of claim 1 wherein the top panel overhangs the front panel and the two side panels.

4. The cat outhouse of claim 1 wherein the top panel includes stops mounted thereto and depending therefrom for preventing relative shifting motion between the top panel and the upper edges of the side panels.

5. The cat outhouse of claim 1 wherein the front panel and the two side panels further include ventilation holes proximate the upper edges thereof.

6. The cat outhouse of claim 1 wherein the front panel includes a front cover removably mounted thereto and adapted to cover the opening therein when the drawer is in the fully retracted position.

7. The cat outhouse of claim 5 wherein the front panel further includes a facing strip to facilitate the retention of the front cover.

8. The cat outhouse of claim 1 which further includes sliding means mounted between the bottom panel and the drawer.

9. The cat outhouse of claim 8 wherein the sliding means comprises plastic runners.

10. The cat outhouse of claim 1 wherein the pass-through door comprises a generally rectangular frame and a plastic flap attached thereto, such frame being mounted within the opening in the back panel and sized to accommodate a cat.

11. The cat outhouse of claim 1 wherein the pass-through door comprises a first generally rectangular frame and a second generally rectangular frame, expanding means therebetween, and a plastic flap attached to the first frame, such first frame being mounted within the opening in the back panel and sized to accommodate a cat and such second frame being spaced apart from the back panel of the shelter.

12. The cat outhouse of claim 1 wherein the pass-through door comprises a first generally rectangular frame and a second generally rectangular frame, expanding means therebetween, and a plastic flap attached to the second frame, such first frame being mounted within the opening in the back panel and sized to accommodate a cat and such second frame being spaced apart from the back panel of the shelter.

13. The cat outhouse of claim 12 wherein the expanding means comprises a first tunnel part mounted to the first frame and a second tunnel part mounted to the second frame, said tunnel parts being capable of nesting into each other and sliding relative to each other.

14. The cat outhouse of claim 13 wherein the first tunnel part and the second tunnel part are capable of expanding to form a tunnel in the range of 4 inches to 6 inches.

15. A pass-through door comprising:
a first generally rectangular frame and a second generally rectangular frame; and
expanding means therebetween, such expanding means comprising a first tunnel part mounted to the first frame and a second tunnel part mounted to the second frame, said tunnel parts being capable of nesting into each other and sliding relative to each other.

16. The pass-through door of claim 15 wherein the first tunnel part and the second tunnel part are capable of expanding to form a tunnel in the range of 4 inches to 6 inches.

17. The pass-through door of claim 15 wherein the fist tunnel part and the second tunnel part each have a cross-section of generally rectangular shape.

18. A method of maintaining a cat litter pan, said litter pan being kept within a drawer within a cat outhouse, said cat outhouse comprising a box-like shelter having a front panel defining an opening therein, and a removable cover retained over said opening, the drawer within said shelter capable of slidably extending through said opening in the front panel of the shelter when the cover has been removed, said method comprising the steps of:
removing the cover; slidably extending the drawer through the opening of the front panel of the shelter; removing the cat litter pan therefrom; servicing the cat litter pan as necessary; replacing the cat litter pan within the drawer; retracting the drawer into the shelter; and replacing the cover.

19. The method of claim 18 wherein the shelter further comprises a removable top panel, and the method further comprises the steps of removing the top panel and cleaning out the interior of the shelter.

20. A method of maintaining a cat litter pan, said litter pan being kept within a drawer within a cat outhouse, said cat outhouse comprising a box-like shelter having a front panel defining an opening therein with a removable cover retained over said opening and a removable top panel, the drawer within said shelter capable of slidably extending through said opening in the front panel of the shelter, said method comprising the steps of:
removing the top panel of the shelter and placing such top panel apart; removing the cat litter pan from the drawer inside the shelter; servicing the cat litter pan as necessary; replacing the cat litter pan within the drawer; and replacing the top panel onto the shelter.
